(19) United States
(12) Patent Application Publication
(10) Pub. No.: US 2021/0097007 A1
(43) Pub. Date: Apr. 1, 2021

(54) ELECTRONIC DEVICE AND CONTROL METHOD

(71) Applicant: CANON KABUSHIKI KAISHA, Tokyo (JP)

(72) Inventor: Hidenori Shiba, Tokyo (JP)

(21) Appl. No.: 17/117,439

(22) Filed: Dec. 10, 2020

Related U.S. Application Data
(63) Continuation of application No. PCT/JP2019/023645, filed on Jun. 14, 2019.

(30) Foreign Application Priority Data
Jun. 15, 2018 (JP) 2018-114416

(51) Int. Cl. G06F 13/14; G06F 13/38; G06F 13/42

(52) U.S. Cl. CPC G06F 13/14; G06F 2213/0042; G06F 13/4282; G06F 13/385

(57) ABSTRACT

An electronic device includes a terminal, a switch, a first resistor and a second resistor that are connected to the terminal via the switch and a controller. The terminal is included in a connector that can be connected to an external apparatus. The controller controls the switch so as to connect the terminal and the second resistor in a case where a voltage of the terminal connected to the first resistor is not within a predetermined voltage range after the switch is controlled so as to connect the terminal and the first resistor, and controls the switch so as to disconnect the terminal and the second resistor and performs control so as to perform a predetermined notification in a case where the voltage of the terminal is within a predetermined voltage range after the switch is controlled so as to connect the terminal and the second resistor.

### CROSS-REFERENCE TO RELATED APPLICATIONS

This application is a Continuation of International Patent Application No. PCT/JP2019/023645, filed Jun. 14, 2019, which claims the benefit of Japanese Patent Application No. 2018-114416, filed Jun. 15, 2018, both of which are hereby incorporated by reference herein in their entirety.

### BACKGROUND

### Field of the Invention

Aspects of the disclosure generally relate to an electronic device that includes a connector conforming to USB Type-C standard, and a control method thereof.

### Background Art

In recent years, portable devices such as digital cameras include a connector conforming to USB (Universal Serial Bus) standard. Japanese Patent Laid-Open No. 2013-109410 describes an apparatus that includes a connector to which a Micro-USB plug is connected. According to USB Type-C standard established after the USB standard was established, a source that supplies power and a sink that receives power are defined. Hereinafter, an apparatus that operates as a source is referred to as a source apparatus, and an apparatus that operates as a sink is referred to as a sink apparatus.

According to the USB Type-C standard, a Type-C connector (Type-C receptacle) of a source apparatus and a Type-C connector (Type-C receptacle) of a sink apparatus have the same shape. Therefore, there is the possibility that two source apparatuses will be connected to each other via a USB Type-C cable or two sink apparatuses will be connected to each other via a USB Type-C cable. However, a state where two source apparatuses are connected to each other via a USB Type-C cable or two sink apparatuses are connected to each other via a USB Type-C cable is an inappropriate connection state, and thus a USB system constituted by two source apparatuses or two sink apparatuses does not operate properly. Therefore, there is demand for a method for determining whether two apparatuses connected to each other via a USB Type-C cable are source apparatuses or sink apparatuses. Furthermore, there is also demand for a method for notifying the user of such a connection state.

### SUMMARY

According to an aspect of the embodiments, an electronic device includes a terminal included in a connector that can be connected to an external apparatus, a switch, a first resistor that is connected to the terminal via the switch, a second resistor that is connected to the terminal via the switch, and a controller that controls the switch so as to connect the terminal and the second resistor in a case where a voltage of the terminal connected to the first resistor is not within a predetermined voltage range after the switch is controlled so as to connect the terminal and the first resistor, and controls the switch so as to disconnect the terminal and the second resistor and perform control so as to perform a predetermined notification in a case where the voltage of the terminal connected to the second resistor is within a predetermined voltage range after the switch is controlled so as to connect the terminal and the second resistor.

According to an aspect of the embodiments, a method includes controlling a switch so as to connect a first resistor to a terminal included in a connector that can be connected to an external apparatus, controlling the switch so as to connect the terminal and a second resistor in a case where a voltage of the terminal connected to the first resistor is not within a predetermined voltage range after the switch is controlled so as to connect the terminal and the first resistor, and controlling the switch so as to disconnect the terminal and the second resistor and performing a predetermined notification in a case where the voltage of the terminal connected to the second resistor is within a predetermined voltage range after the switch is controlled so as to connect the terminal and the second resistor.

According to an aspect of the embodiments, a non-transitory storage medium that stores a program causing a computer to execute a method, wherein the method includes controlling a switch so as to connect a first resistor to a terminal included in a connector that can be connected to an external apparatus, controlling the switch so as to connect the terminal and a second resistor in a case where a voltage of the terminal connected to the first resistor is not within a predetermined voltage range after the switch is controlled so as to connect the terminal and the first resistor, and controlling the switch so as to disconnect the terminal and the second resistor and performing a predetermined notification in a case where the voltage of the terminal connected to the second resistor is within a predetermined voltage range after the switch is controlled so as to connect the terminal and the second resistor.

Further aspects of the embodiments will become apparent from the following embodiments.

### BRIEF DESCRIPTION OF THE DRAWINGS

FIG. 1 is a block diagram for illustrating components of an electronic device 100 according to a first embodiment.

FIG. 2 is a block diagram for illustrating components of a source apparatus 200.

FIG. 3 is a block diagram for illustrating components of a sink apparatus 300.

FIG. 4 is a flowchart for illustrating an example of a process 400 that is performed by the source apparatus 200.

FIG. 5 is a flowchart for illustrating an example of a process 500 that is performed by the sink apparatus 300.

FIG. 6 is a flowchart for illustrating an example of a process 600 that is performed by the electronic device 100 when the electronic device 100 operates as a sink.

FIG. 7 is a flowchart for illustrating an example of a process 700 that is performed by the electronic device 100 when the electronic device 100 operates as a source.

FIG. 8 is diagram illustrating a state where the source apparatus 200 and the sink apparatus 300 are connected via a USB Type-C cable 801.

### DESCRIPTION OF THE EMBODIMENTS

Exemplary embodiments, features, and aspects of the disclosure will be described below with reference to the drawings. Note that aspects of the disclosure are not limited to the following embodiments.

### First Embodiment

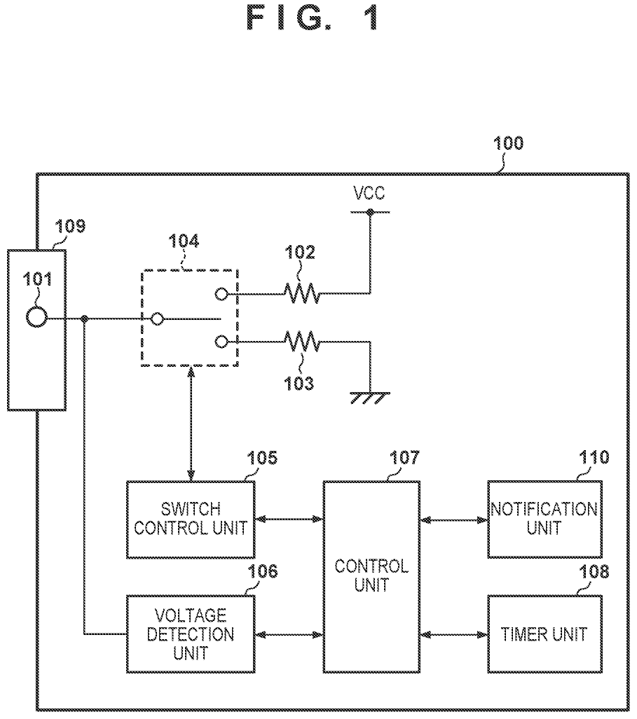

Components of an electronic device 100 according to a first embodiment will be described with reference to FIG. 1. The electronic device 100 has a function for determining whether an external apparatus connected to the electronic device 100 is a sink apparatus or a source apparatus. In the first embodiment and another embodiment, an apparatus that operates as a sink conforming to USB Type-C standard is referred to as a sink apparatus, and an apparatus that operates as a source conforming to the USB Type-C standard is referred to as a source apparatus.

The electronic device 100 includes a pull-up resistor 102, a pull-down resistor 103, a switch 104, a switch control unit 105, a voltage detection unit 106, a control unit 107, a timer unit 108, a connector 109, and a notification unit 110. Note that the electronic device 100 includes components besides these components, but, in the first embodiment, a description of such components is omitted.

The connector 10 is a connector (Type-C receptacle) conforming to the USB Type-C standard. An external apparatus can be connected to the connector 109 via a USB Type-C cable. The connector 109 includes a CC (Configuration Channel) terminal 101 conforming to the USB Type-C standard. Note that the connector 109 further includes a VBUS terminal, a D+ terminal, a D− terminal, a GND (ground) terminal, and the like, which are not illustrated. The VBUS terminal is used when supplying/receiving power to/from the external apparatus connected via the USB Type-C cable. The D+ terminal and the D− terminal are terminals for performing data communication. The GND terminal is connected to a ground portion that is used as a reference level of a signal.

One end of the pull-up resistor 102 is connected to a power supply VCC of the electronic device 100. The other end of the pull-up resistor 102 can be connected to the CC terminal 101 via the switch 104. One end of the pull-down resistor 103 is connected to a ground portion. The other end of the pull-down resistor 103 can be connected to the CC terminal 101 via the switch 104.

The switch 104 is a switch for selecting one of a first state, a second state, and a third state. The switch control unit 105 controls the switch 104 so as to select one of the first state, the second state, and the third state. The first state is a state where the pull-up resistor 102 is connected to the CC terminal 101 but the pull-down resistor 103 is disconnected from the CC terminal 101. When the switch 104 enters the first state, the CC terminal 101 is pulled up. The second state is a state where the pull-down resistor 103 is connected to the CC terminal 101 but the pull-up resistor 102 is disconnected from the CC terminal 101. When the switch 104 enters the second state, the CC terminal 101 is pulled down. The third state is a state where both the pull-up resistor 102 and the pull-down resistor 103 are disconnected from the CC terminal 101. When the switch 104 enters the third state, the CC terminal 101 enters a so-called open state (a state other than a pull-up state and pull-down state). Note that operations of the switch control unit 105 are controlled by the control unit 107.

The voltage detection unit 106 monitors the voltage of a CC terminal 301 by continuously detecting the voltage of the CC terminal 101. The voltage detection unit 106 can determine whether or not an external apparatus has been connected to the electronic device 100, based on a change in the voltage of the CC terminal 101. When the electronic device 100 operates as a source, the voltage detection unit 106 can determine whether or not the voltage of the CC terminal 101 is within a first voltage range. When the electronic device 100 operates as a sink, the voltage detection unit 106 can determine whether or not the voltage of the CC terminal 101 is within a second voltage range. Both the first and second voltage ranges are voltage ranges determined in accordance with the USB Type-C standard. Information indicating the first and second voltage ranges is stored in a memory in the voltage detection unit 106. The first voltage range is a voltage range that changes according to the power supply capability (15 W, 7.5 W, 2.5 W) of the electronic device 100 that operates as a source. For example, when the power supply capability of the electronic device 100 is 15 W (3 A, 5 V), the first voltage range is a range that is higher than or equal to 0.85 V and lower than or equal to 2.45 V. For example, when the power supply capability of the electronic device 100 is 7.5 W (1.5 A, 5 V), the first voltage range is a range that is higher than or equal to 0.45 V and lower than or equal to 1.50 V. For example, when the power supply capability of the electronic device 100 is 2.5 W (0.5 A, 5 V), the first voltage range is a range that is higher than or equal to 0.25 V and lower than or equal to 1.50 V. The second voltage range is a voltage range that changes according to the power supply capability (15 W, 7.5 W, 2.5 W) of the source apparatus connected to the electronic device 100. For example, when the power supply capability of the source apparatus is 15 W (3 A, 5 V), the second voltage range is a voltage range higher than or equal to 1.31 V and lower than or equal to 2.04 V. For example, when the power supply capability of the source apparatus is 7.5 W (1.5 A, 5 V), the second voltage range is a voltage range higher than or equal to 0.70 V and lower than or equal to 1.16V. For example, when the power supply capability of the source apparatus is 2.5 W (0.5 A, 5 V), the second voltage range is a voltage range higher than or equal to 0.25 V and lower than or equal to 0.61 V.

The control unit 107 includes a memory and a processor (for example, hardware processor). The memory of the control unit 107 stores a program for controlling the components of the electronic device 100. The processor of the control unit 107 controls the components of the electronic device 100 by executing the program stored in the memory of the control unit 107. The control unit 107 can determine the type of the external apparatus connected to the electronic device 100 by controlling the components of the electronic device 100 in accordance with the program stored in the memory. Processes 600 and 700 to be described later can be executed, for example, as a result of the processor of the control unit 107 controlling the components of the electronic device 100 in accordance with the program stored in the memory of the control unit 107.

The timer unit 108 can determine whether or not a first wait time or a second wait time has elapsed. The timer unit 108 is connected to the control unit 107. The timer unit 108 starts counting the first wait time or the second wait time in accordance with a request from the control unit 107. The timer unit 108 supplies, to the control unit 107, a signal indicating whether or not the first wait time or the second wait time has elapsed. The first wait time is a time that is longer than or equal to 100 ms and shorter than or equal to 200 ms, for example. Note that the first wait time is a time corresponding to tCCDebounce determined according to the USB Type-C standard. The second wait time is a time that is shorter than the first wait time. The second wait time is a time that is longer than or equal to 10 ms and shorter than 100 ms, for example.

The notification unit 110 performs a predetermined notification. The predetermined notification includes a process for visually, auditorily, or tactually outputting predetermined notification information informing the user that the connection state between the electronic device 100 and the external apparatus is an inappropriate connection state. When both the electronic device 100 and the external apparatus are sink apparatuses, the connection state between the electronic device 100 and the external apparatus is an inappropriate connection state. Also when both the electronic device 100 and the external apparatus are source apparatuses, the connection state between the electronic device 100 and the external apparatus is an inappropriate connection state. The predetermined notification information that is visually, auditorily, or tactually output may be any information that includes information for informing the user that the connection state between the electronic device 100 and the external apparatus is an inappropriate connection state. The predetermined notification information includes, for example, all or at least one of a predetermined message, a predetermined icon, predetermined sound, and predetermined vibration. If the notification unit 110 includes a display, the notification unit 110 visually outputs the predetermined notification information by displaying the predetermined message or the predetermined icon on the display. If the notification unit 110 includes a speaker, the notification unit 110 auditorily outputs the predetermined notification information by outputting the predetermined sound from the speaker. If the notification unit 110 includes a vibration unit, the notification unit 110 tactually outputs the predetermined notification information by causing the vibration unit to perform predetermined vibration.

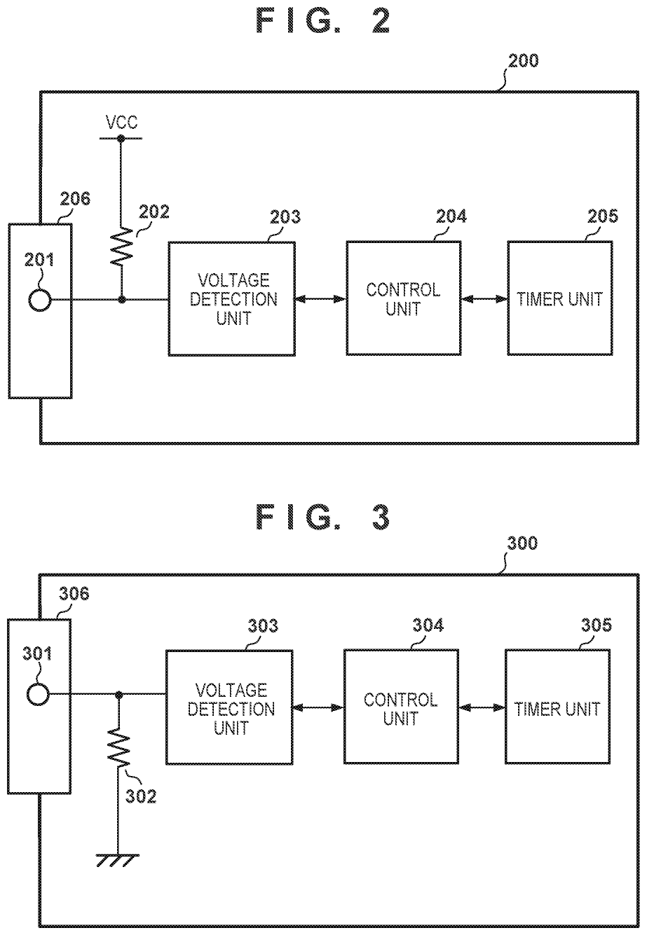

Next, components of the source apparatus 200 will be described with reference to FIG. 2.

The source apparatus 200 includes a pull-up resistor 202, a voltage detection unit 203, a control unit 204, a timer unit 205, and a connector 206. Note that the source apparatus 200 includes components besides these components, but, in the first embodiment, a description of such components is omitted.

The connector 206 is a connector (Type-C receptacle) conforming to the USB Type-C standard. An external apparatus can be connected to the connector 206 via a USB Type-C cable. The connector 206 includes a CC terminal 201 conforming to the USB Type-C standard. Note that the connector 206 further includes a VBUS terminal, a D+ terminal, a D− terminal, a GND (ground) terminal, and the like, which are not illustrated.

One end of the pull-up resistor 202 is connected to a power supply VCC of the source apparatus 200. The other end of the pull-up resistor 202 is connected to the CC terminal 201.

The voltage detection unit 203 monitors the voltage of the CC terminal 301 by continuously detecting the voltage of the CC terminal 201. The voltage detection unit 203 can determine whether or not an external apparatus has been connected to the source apparatus 200, based on a change in the voltage of the CC terminal 101. Furthermore, the voltage detection unit 203 can determine whether or not the voltage of the CC terminal 201 is within the above-described first voltage range. As described above, the first voltage range is a voltage range that changes according to the power supply capability (15 W, 7.5 W, 2.5 W) of the source apparatus 200. Information indicating the first voltage range is stored in the memory in the voltage detection unit 203.

The control unit 204 includes a memory and a processor (for example, hardware processor). The memory of the control unit 204 stores a program for controlling the components of the source apparatus 200. The processor of the control unit 204 controls the components of the source apparatus 200 by executing the program stored in the memory of the control unit 204. The control unit 204 can determine the type of the external apparatus connected to the source apparatus 200 by controlling the components of the source apparatus 200 in accordance with the program stored in the memory. A process 400 to be described later can be executed, for example, as a result of the processor of the control unit 204 controlling the components of the source apparatus 200 in accordance with the program stored in the memory of the control unit 204.

The timer unit 205 can determine whether or not the above-described first wait time (e.g., a period of time that is longer than or equal to 100 ms and shorter than or equal to 200 ms) has elapsed. The timer unit 205 is connected to the control unit 204. The timer unit 205 starts counting the first wait time in accordance with a request from the control unit 204. The timer unit 205 supplies, to the control unit 204, a signal indicating whether or not the first wait time has elapsed.

Next, components of the sink apparatus 300 will be described with reference to FIG. 3. The sink apparatus 300 includes a connector 306, a pull-down resistor 302, a voltage detection unit 303, a control unit 304, and a timer unit 305. Note that the sink apparatus 300 includes components besides these components, but, in the first embodiment, a description of such components is omitted.

The connector 306 is a connector (Type-C receptacle) conforming to the USB Type-C standard. An external apparatus can be connected to the connector 306 via a USB Type-C cable. The connector 306 includes the CC terminal 301 conforming to the USB Type-C standard. Note that the connector 306 further includes a VBUS terminal, a D+ terminal, a D− terminal, a GND (ground) terminal, and the like, which are not illustrated.

One end of the pull-down resistor 302 is connected to a ground portion. The other end of the pull-down resistor 302 is connected to the CC terminal 301.

The voltage detection unit 303 monitors the voltage of the CC terminal 301 by continuously detecting the voltage of the CC terminal 301. The voltage detection unit 303 can determine whether or not an external apparatus has been connected to the sink apparatus 300, based on a change in the voltage of the CC terminal 101. Furthermore, the voltage detection unit 303 can determine whether or not the voltage of the CC terminal 301 is within the above-described the second voltage range. As described above, the second voltage range is a voltage range that changes according to the power supply capability (15 W, 7.5 W, 2.5 W) of the source apparatus 200. Information indicating the second voltage range stored in a memory in the voltage detection unit 303.

The control unit 304 includes a memory and a processor (ex. hardware processor). The memory of the control unit 304 stores a program for controlling the components of the sink apparatus 300. The processor of the control unit 304 controls the components of the sink apparatus 300 by executing the program stored in the memory of the control unit 304. The control unit 304 can determine the type of the external apparatus connected to the sink apparatus 30, by controlling the components of the sink apparatus 300 in accordance with the program stored in the memory. A process 500 to be described later can be executed, for example, as a result of the processor of the control unit 304 controlling the components of the sink apparatus 300 in accordance with the program stored in the memory of the control unit 304.

The timer unit 305 can determine whether or not the above-described first wait time (e.g., a period of time that is longer than or equal to 100 ms and shorter than or equal to 200 ms) has elapsed. The timer unit 305 is connected to the control unit 304. The timer unit 305 starts counting the first wait time in accordance with a request from the control unit 304. The timer unit 305 supplies, to the control unit 304, a signal indicating whether or not the first wait time has elapsed.

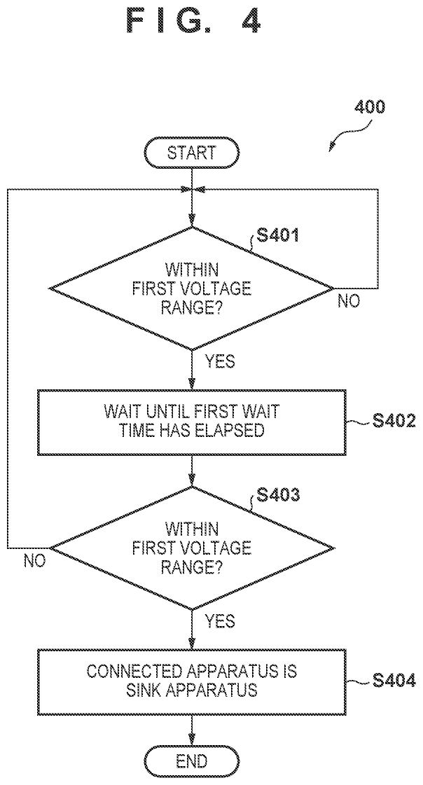

Next, an example of the process 400 that is performed by the source apparatus 200 will be described with reference to the flowchart in FIG. 4. The process 400 is started when the source apparatus 200 and the sink apparatus 300 are connected via a USB Type-C cable.

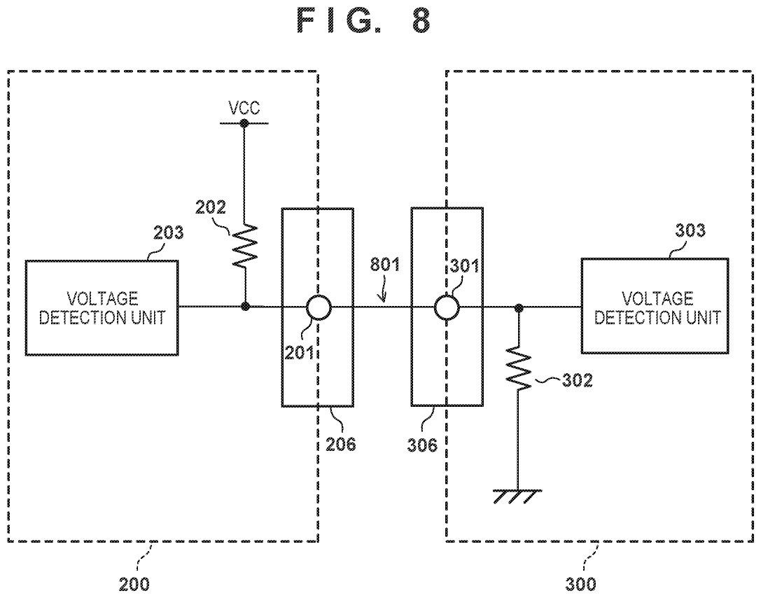

In step S401, the voltage detection unit 203 determines whether or not the voltage of the CC terminal 201 is within the above-described first voltage range. FIG. 8 is diagram for illustrating a state where the source apparatus 200 and the sink apparatus 300 are connected via the USB Type-C cable 801. When the source apparatus 200 and the sink apparatus 300 are connected via the USB Type-C cable 801, the voltage of the CC terminal 201 is within the first voltage range. If the voltage of the CC terminal 201 is within the first voltage range, a signal indicating that the voltage of the CC terminal 201 is within the first voltage range is supplied from the voltage detection unit 203 to the control unit 204 (YES in step S401). The process 400 then advances from step S401 to step S402. On the other hand, if the voltage of the CC terminal 201 is not within the first voltage range, step S401 is repeated (NO in step S401).

In step S402, the control unit 204 requests the timer unit 205 to start counting the above-described first wait time (e.g., a period of time that is longer than or equal to 100 ms and is shorter than or equal to 200 ms). The timer unit 205 starts counting the first wait time. If the timer unit 205 determines that the first wait time has elapsed, the timer unit 205 supplies, to the control unit 204, a signal indicating that the first wait time has elapsed. After the first wait time has elapsed, the process 400 advances from step S402 to step S403.

In step S403, the voltage detection unit 203 determines whether or not the voltage of the CC terminal 201 is within the above-described first voltage range. If the voltage of the CC terminal 201 is within the first voltage range, a signal indicating that the voltage of the CC terminal 201 is within the first voltage range is notified from the voltage detection unit 203 to the control unit 204 (YES in step S403). The process 400 then advances from step S403 to step S404. On the other hand, if the voltage of the CC terminal 201 is not within the first voltage range, the process 400 advances from step S403 to step S401 (NO in step S403).

In step S404, the control unit 204 determines that the external apparatus connected to the source apparatus 200 via the USB Type-C cable is the sink apparatus 300.

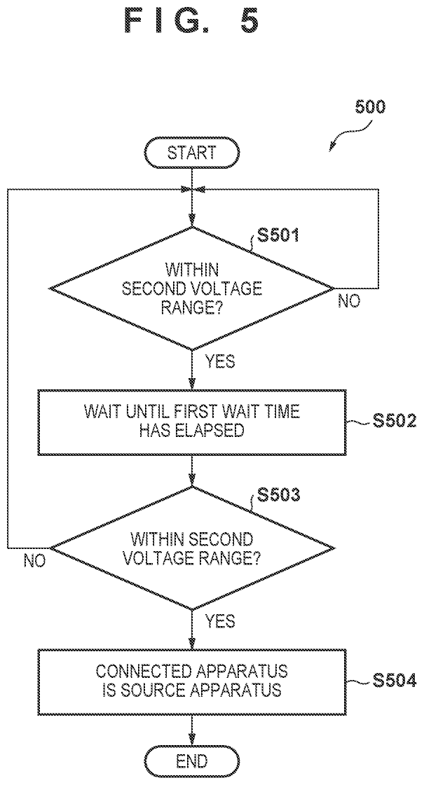

Next, an example of the process 500 that is performed by the sink apparatus 300 will be described with reference to the flowchart in FIG. 5. The process 500 is started when the source apparatus 200 and the sink apparatus 300 are connected via USB Type-C cable.

In step S501, the voltage detection unit 303 determines whether or not the voltage of the CC terminal 301 is within the above-described the second voltage range. FIG. 8 is a diagram for illustrating a state where the source apparatus 200 and the sink apparatus 300 are connected via the USB Type-C cable 801. When the source apparatus 200 and the sink apparatus 300 are connected via the USB Type-C cable 801, the voltage of the CC terminal 301 is within the second voltage range. If the voltage of the CC terminal 301 is within the second voltage range, a signal indicating that the voltage of the CC terminal 301 is within the second voltage range is supplied from the voltage detection unit 303 to the control unit 304 (YES in step S501). The process 500 then advances from step S501 to step S502. On the other hand, if the voltage of the CC terminal 301 is not within the second voltage range, step S501 is repeated (NO in step S501).

In step S502, the control unit 304 requests the timer unit 305 to start counting the above-described first wait time (e.g., a period of time that is longer than or equal to 100 ms and is shorter than or equal to 200 ms). The timer unit 305 starts counting the first wait time. If the timer unit 305 determines that the first wait time has elapsed, the timer unit 305 supplies, to the control unit 304, a signal indicating that the first wait time has elapsed. After the first wait time has elapsed, the process 500 advances from step S502 to step S503.

In step S503, the voltage detection unit 303 determines whether or not the voltage of the CC terminal 301 is within the above-described the second voltage range. If the voltage of the CC terminal 301 is within the second voltage range, a signal indicating that the voltage of the CC terminal 301 is within the second voltage range is supplied from the voltage detection unit 303 to the control unit 304 (YES in step S503). The process 500 then advances from step S503 to step S504. On the other hand, if the voltage of the CC terminal 301 is not within the second voltage range, the process 500 advances from step S503 to step S501 (NO in step S503).

In step S504, the control unit 304 determines that the external apparatus connected to the sink apparatus 300 via the USB Type-C cable is the source apparatus 200.

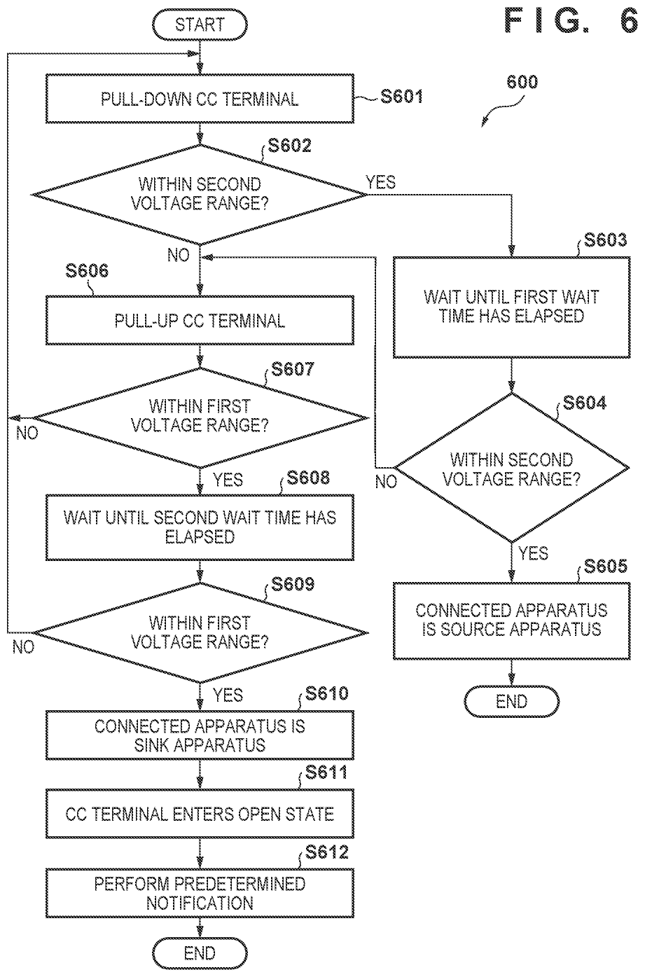

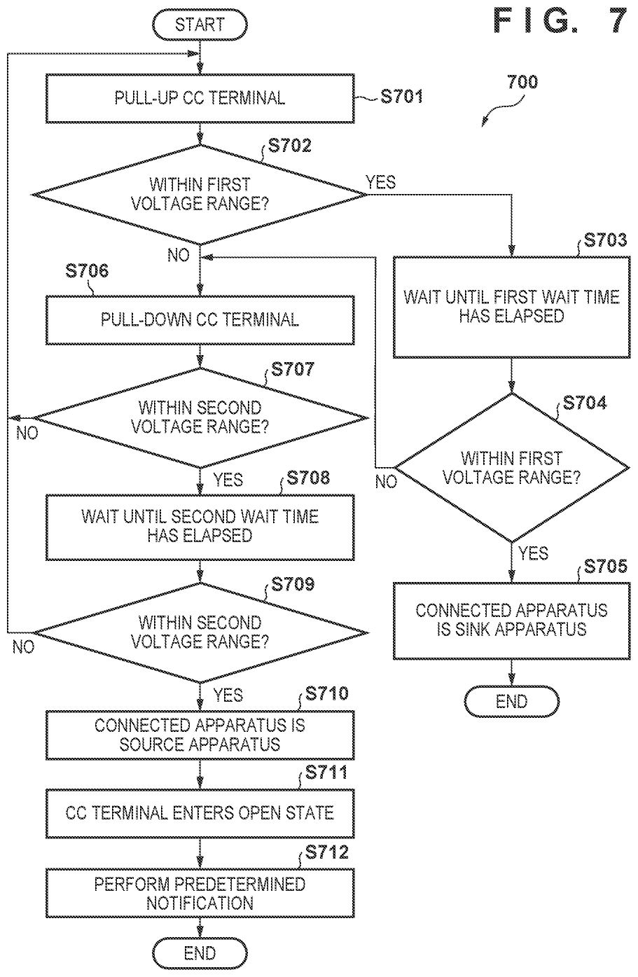

Next, an example of the process 600 that is performed by the electronic device 100 when the electronic device 100 operates as a sink conforming to the USB Type-C standard will be described with reference to the flowchart in FIG. 6. The process 600 is started when the electronic device 100 and an external apparatus (the source apparatus 200 or the sink apparatus 300) are connected via the USB Type-C cable.

In step S601, the switch control unit 105 controls the switch 104 so as to enter the above-described second state. As described above, the second state is a state where the pull-down resistor 103 is connected to the CC terminal 101 but the pull-up resistor 102 is disconnected from the CC terminal 101. When the switch 104 enters the second state, the CC terminal 101 is pulled down. After the switch 104 has entered the second state, the process 600 advances from step S601 to step S602.

In step S602, the voltage detection unit 106 determines whether or not the voltage of the CC terminal 101 is within the above-described second voltage range. If the voltage of the CC terminal 101 is within the second voltage range, a signal indicating that the voltage of the CC terminal 101 is within the second voltage range is supplied from the voltage detection unit 106 to the control unit 107 (YES in step S602). The process 600 then advances from step S602 to step S603. If the voltage of the CC terminal 101 is not within the second voltage range, the process 600 advances from step S602 to step S606 (NO in step S602).

In step S603, the control unit 107 requests the timer unit 108 to start counting the above-described first wait time (e.g., a period of time that is longer than or equal to 100 ms and shorter than or equal to 200 ms). The timer unit 108 starts counting the first wait time. If the timer unit 108 determines that the first wait time has elapsed, the timer unit 108 supplies, to the control unit 107, a signal indicating that the first wait time has elapsed. After the first wait time has elapsed, the process 600 advances from step S603 to step S604.

In step S604, the voltage detection unit 106 determines whether or not the voltage of the CC terminal 101 is within the above-described second voltage range. If the voltage of the CC terminal 101 is within the second voltage range, a signal indicating that the voltage of the CC terminal 101 is within the second voltage range is supplied from the voltage detection unit 106 to the control unit 107 (YES in step S604). The process 600 then advances from step S604 to step S605. If the voltage of the CC terminal 101 is not within the second voltage range, a signal indicating that the voltage of the CC terminal 101 is not within the second voltage is supplied from the voltage detection unit 106 to the control unit 107 (NO in step S604). The process 600 then advances from step S604 to step S606.

In step S605, the control unit 107 determines that an external apparatus connected to the electronic device 100 that operates as a sink, via a USB Type-C cable, is the source apparatus 200. This is a state where the source apparatus 200 is connected to the electronic device 100 that operates as a sink, and thus the control unit 107 determines that the connection state between the electronic device 100 and the source apparatus 200 is a proper connection state. The process 600 shown in FIG. 6 then ends.

In step S606, the switch control unit 105 controls the switch 104 so as to enter the above-described first state. As described above, the first state is a state where the pull-up resistor 102 is connected to the CC terminal 101 but the pull-down resistor 103 is disconnected from the CC terminal 101. When the switch 104 enters the first state, the CC terminal 101 is pulled up. After the switch 104 has entered the first state, the process 600 advances from step S606 to step S607.

In step S607, the voltage detection unit 106 determines whether or not the voltage of the CC terminal 101 is within the first voltage range. If the voltage of the CC terminal 101 is within the first voltage range, a signal indicating that the voltage of the CC terminal 101 is within the first voltage range is supplied from the voltage detection unit 106 to the control unit 107 (YES in step S607). The process 600 then advances from step S607 to step S608. If the voltage of the CC terminal 101 is not within the first voltage range, a signal indicating that the voltage of the CC terminal 101 is not within the first voltage range is supplied from the voltage detection unit 106 to the control unit 107 (NO in step S607). The process 600 then advances from step S607 to step S601.

In step S608, the control unit 107 requests the timer unit 108 to start counting the above-described second wait time (e.g., a period of time that is longer than or equal to 10 ms and shorter than 100 ms). The timer unit 108 starts counting the second wait time. If the timer unit 108 determines that the second wait time has elapsed, the timer unit 108 supplies, to the control unit 107, a signal indicating that the second wait time has elapsed. After the second wait time has elapsed, the process 600 advances from step S608 to step S609.

In step S609, the voltage detection unit 106 determines whether or not the voltage of the CC terminal 101 is within the first voltage range. If the voltage of the CC terminal 101 is within the first voltage range, a signal indicating that the voltage of the CC terminal 101 is within the first voltage range is supplied from the voltage detection unit 106 to the control unit 107 (YES in step S609). The process 600 then advances from step S609 to step S610. If the voltage of the CC terminal 101 is not within the first voltage range, a signal indicating that the voltage of the CC terminal 101 is not within the first voltage range is supplied from the voltage detection unit 106 to the control unit 107 (NO in step S609). The process 600 then advances from step S609 to step S601. Note that, after it is determined in step S608 that the second wait time has elapsed, a determination is performed on whether or not the voltage of the CC terminal 101 is within the first voltage range, again in step S609, in order to eliminate erroneous determination in step S607. For example, when the voltage of the CC terminal 101 increases due to exogenous noise and the like, a determination is erroneously performed in step S607 that the voltage of the CC terminal 101 is within the first voltage range. In order to eliminate such erroneous determination, after it is determined in step S608 that the second wait time has elapsed, a determination is performed on whether or not the voltage of the CC terminal 101 is within the first voltage range, again in step S609

In step S610, the control unit 107 determines that the external apparatus connected to the electronic device 100 that operates as a sink, via the USB Type-C cable, is the sink apparatus 300. This is a state where the sink apparatus 300 is connected to the electronic device 100 that operates as a sink, and thus the control unit 107 determines that the connection state between the electronic device 100 and the sink apparatus 300 is an inappropriate connection state. The process 600 then advances to step S611.

In step S611, the switch control unit 105 controls the switch 104 so as to enter the above-described third state. As described above, the third state is a state where both the pull-up resistor 102 and the pull-down resistor 103 are disconnected from the CC terminal 101. When the switch 104 enters the third state, the CC terminal 101 enters a so-called open state (a state other than pull-up state and pull-down state). After the switch 104 has entered the third state, the process 600 advances from step S611 to step S612. Note that a case has been described in which the switch 104 is controlled so as to enter the third state in step S611, as an example, but the switch 104 may also be controlled so as to enter the above-described first state.

In step S612, the control unit 107 controls the notification unit 110 so as to perform a predetermined notification. Note that the notification unit 110 performs the predetermined notification, since the sink apparatus 300 is connected to the electronic device 100 that operates as a sink and the connection state between the electronic device 100 and the sink apparatus 300 is an inappropriate connection state. As a result of the predetermined notification being performed, the user can be informed that the connection between the electronic device 100 and the sink apparatus 300 is a connection between sink apparatuses. After the notification unit 110 has performed the predetermined notification, the process 600 shown in FIG. 6 ends.

As described above, according to the first embodiment, it is possible to determine whether or not the sink apparatus 300 is connected to the electronic device 100 that operates as a sink. Furthermore, according to the first embodiment, when the sink apparatus 300 is connected to the electronic device 100 that operates as a sink, it is possible to notify the user that the connection state between the electronic device 100 and the external apparatus is an inappropriate connection state. Such a notification enables the user to review the connection state between the electronic device 100 and external apparatus.

Next, an example of the process 700 that is performed by the electronic device 100 when the electronic device 100 operates as a source conforming to the USB Type-C standard will be described with reference to the flowchart in FIG. 7. The process 700 is started when the electronic device 100 and an external apparatus (the source apparatus 200 or the sink apparatus 300) are connected via the USB Type-C cable.

In step S701, the switch control unit 105 controls the switch 104 so as to enter the above-described first state. As described above, the first state is a state where the pull-up resistor 102 is connected to the CC terminal 101 but the pull-down resistor 103 is disconnected from the CC terminal 101. When the switch 104 enters the first state, the CC terminal 101 is pulled up. After the switch 104 has entered the first state, the process 700 advances from step S701 to step S702.

In step S702, the voltage detection unit 106 determines whether or not the voltage of the CC terminal 101 is within the first voltage range. If the voltage of the CC terminal 101 is within the first voltage range, a signal indicating that the voltage of the CC terminal 101 is within the first voltage range is supplied from the voltage detection unit 106 to the control unit 107 (YES in step S702). The process 700 then advances from step S702 to step S703. If the voltage of the CC terminal 101 is not within the first voltage range, the process 700 advances from step S702 to step S706 (NO in step S702).

In step S703, the control unit 107 requests the timer unit 108 to start counting the above-described first wait time (e.g., a period of time that is longer than or equal to 100 ms and shorter than or equal to 200 ms). The timer unit 108 starts counting the first wait time. When the timer unit 108 determines that the first wait time has elapsed, the timer unit 108 supplies, to the control unit 107, a signal indicating that the first wait time has elapsed. After the first wait time has elapsed, the process 700 advances from step S703 to step S704.

In step S704, the voltage detection unit 106 determines whether or not the voltage of the CC terminal 101 is within the first voltage range. If the voltage of the CC terminal 101 is within the first voltage range, a signal indicating that the voltage of the CC terminal 101 is within the first voltage range is supplied from the voltage detection unit 106 to the control unit 107 (YES in step S704). The process 700 then advances from step S704 to step S705. If the voltage of the CC terminal 101 is not within the first voltage range, a signal indicating that the voltage of the CC terminal 101 is not within the first voltage range is supplied from the voltage detection unit 106 to the control unit 107 (NO in step S704). The process 700 then advances from step S704 to step S706.

In step S705, the control unit 107 determines that the external apparatus connected to the electronic device 100 that operates as a source, via the USB Type-C cable, is the sink apparatus 300. This is a state where the sink apparatus 300 is connected to the electronic device 100 that operates as a source, and thus the control unit 107 determines that the connection state between the electronic device 100 and the sink apparatus 300 is a proper connection state. The process 700 shown in FIG. 7 then ends.

In step S706, the switch control unit 105 controls the switch 104 so as to enter the above-described second state. As described above, the second state is a state where the pull-down resistor 103 is connected to the CC terminal 101 but the pull-up resistor 102 is disconnected from the CC terminal 101. When the switch 104 enters the second state, the CC terminal 101 is pulled down. After the switch 104 has entered the second state, the process 700 advances from step S706 to step S707.

In step S707, the voltage detection unit 106 determines whether or not the voltage of the CC terminal 101 is within the second voltage range. If the voltage of the CC terminal 101 is within the second voltage range, a signal indicating that the voltage of the CC terminal 101 is within the second voltage range is supplied from the voltage detection unit 106 to the control unit 107 (YES in step S707). The process 700 then advances from step S707 to step S708. When the voltage of the CC terminal 101 is not within the second voltage range, a signal indicating that the voltage of the CC terminal 101 is not within the second voltage range is supplied from the voltage detection unit 106 to the control unit 107 (NO in step S707). The process 700 then advances from step S707 to step S701.

In step S708, the control unit 107 requests the timer unit 108 to start counting the above-described second wait time (e.g., a period of time that is longer than or equal to 10 ms and shorter than 100 ms). The timer unit 108 starts counting the second wait time. If the timer unit 108 determines that the second wait time has elapsed, the timer unit 108 supplies, to the control unit 107, a signal indicating that the second wait time has elapsed. After the second wait time has elapsed, the process 700 advances from step S708 to step S709.

In step S709, the voltage detection unit 106 determines whether or not the voltage of the CC terminal 101 is within the second voltage range. If the voltage of the CC terminal 101 is within the second voltage range, a signal indicating that the voltage of the CC terminal 101 is within the second voltage range is supplied from the voltage detection unit 106 to the control unit 107 (YES in step S709). The process 700 then advances from step S709 to step S710. If the voltage of the CC terminal 101 is not within the second voltage range, a signal indicating that the voltage of the CC terminal 101 is not within the second voltage range is supplied from the voltage detection unit 106 to the control unit 107 (NO in step S709). The process 700 then advances from step S709 to step S701. Note that, after it is determined in step S708 that the second wait time has elapsed, a determination is performed on whether or not the voltage of the CC terminal 101 is within the second voltage range, again in step S709, in order to eliminate erroneous determination in step S707. For example, when the voltage of the CC terminal 101 increases due to exogenous noise and the like, a determination is erroneously made in step S707 that the voltage of the CC terminal 101 is within the second voltage range. In order to eliminate such erroneous determination, after the second wait time has elapsed in step S708, a determination is performed on whether or not the voltage of the CC terminal 101 is within the second voltage range, again in step S709.

In step S710, the control unit 107 determines that the external apparatus connected to the electronic device 100 that operates as a source, via the USB Type-C cable, is the source apparatus 200. This is a state where the source apparatus 200 is connected to the electronic device 100 that operates as a source, and thus the control unit 107 determines that the connection state between the electronic device 100 and the source apparatus 200 is an inappropriate connection state. The process 700 then advances to step S711.

In step S711, the switch control unit 105 controls the switch 104 so as to enter the above-described third state. As described above, the third state is a state where both the pull-up resistor 102 and the pull-down resistor 103 are disconnected from the CC terminal 101. When the switch 104 enters the third state, the CC terminal 101 enters a so-called open state (a state other than a pull-up state and a pull-down state). After the switch 104 has entered the third state, the process 700 advances from step S711 to step S712. Note that a case has been described in which the switch 104 is controlled so as to enter the third state in step S711, as an example, but the switch 104 may also be controlled so as to enter the above-described first state.

In step S712, the control unit 107 controls the notification unit 110 so as to perform a predetermined notification. Note that the notification unit 110 performs the predetermined notification since the source apparatus 200 is connected to the electronic device 100 that operates as a source and the connection state between the electronic device 100 and the source apparatus 200 is an inappropriate connection state. As a result of the predetermined notification being performed, the user can be informed that the connection between the electronic device 100 and the source apparatus 200 is a connection between source apparatuses. After the notification unit 110 has performed predetermined notification, the process 700 shown in FIG. 7 ends.

As described above, according to the first embodiment, it is possible to determine whether or not the source apparatus 200 is connected to the electronic device 100 that operates as a source. Furthermore, according to the first embodiment, when the source apparatus 200 is connected to the electronic device 100 that operates as a source, it is possible to notify the user that the connection state between the electronic device 100 and the external apparatus is an inappropriate connection state. Such notification enables the user to review the connection state between the electronic device 100 and the external apparatus.

### Second Embodiment

Various functions, processes, or methods described in the first embodiment can also be realized by a personal computer, a microcomputer, a CPU (Central Processing Unit), a processor, or the like using a program. Hereinafter, in a second embodiment, a personal computer, a microcomputer, a CPU (Central Processing Unit), a processor, or the like is referred to as a “computer X”. In addition, in the second embodiment, the program for controlling the computer X and for realizing the various functions, processes, or methods described in the first embodiment is referred to as a “program Y”.

The various functions, processes, or methods described in the first embodiment are realized as a result of the computer X executing the program Y. In this case, the program Y is supplied to the computer X via a computer-readable storage medium. A computer-readable storage medium according to the second embodiment includes at least one of a hard disk apparatus, a magnetic storage apparatus, an optical storage apparatus, an optical magnetic storage apparatus, a memory card, a volatile memory, anon-volatile memory, and the like. The computer-readable storage medium according to the second embodiment is a non-transitory storage medium.

While aspects of the disclosure are described with reference to above embodiments, it is to be understood that the aspects of the disclosure are not limited to the above embodiments. The scope of the following claims is to be accorded the broadest interpretation so as to encompass all such modifications and equivalent structures.

1. An electronic device comprising:
a terminal included in a connector that can be connected to an external apparatus;
a switch;
a first resistor that is connected to the terminal via the switch;
a second resistor that is connected to the terminal via the switch; and
a controller that controls the switch so as to connect the terminal and the second resistor in a case where a voltage of the terminal connected to the first resistor is not within a predetermined voltage range after the switch is controlled so as to connect the terminal and the first resistor, and controls the switch so as to disconnect the terminal and the second resistor and perform control so as to perform a predetermined notification in a case where the voltage of the terminal connected to the second resistor is within a predetermined voltage range after the switch is controlled so as to connect the terminal and the second resistor.

2. The electronic device according to claim 1, wherein the first resistor is a pull-down resistor, and
the second resistor is a pull-up resistor.

3. The electronic device according to claim 1, wherein the first resistor is a pull-up resistor, and
the second resistor is a pull-down resistor.

4. The electronic device according to claim 1, further comprising:
a notification device that performs the predetermined notification.

5. The electronic device according to claim 1, wherein the terminal is a CC terminal conforming to USB Type-C standard.

6. A method comprising:
controlling a switch so as to connect a first resistor to a terminal included in a connector that can be connected to an external apparatus;
controlling the switch so as to connect the terminal and a second resistor in a case where a voltage of the terminal connected to the first resistor is not within a predetermined voltage range after the switch is controlled so as to connect the terminal and the first resistor; and
controlling the switch so as to disconnect the terminal and the second resistor and performing a predetermined notification in a case where the voltage of the terminal connected to the second resistor is within a predetermined voltage range after the switch is controlled so as to connect the terminal and the second resistor.

7. A non-transitory storage medium that stores a program causing a computer to execute a method, the method comprising:
controlling a switch so as to connect a first resistor to a terminal included in a connector that can be connected to an external apparatus;
controlling the switch so as to connect the terminal and a second resistor in a case where a voltage of the terminal connected to the first resistor is not within a predetermined voltage range after the switch is controlled so as to connect the terminal and the first resistor; and
controlling the switch so as to disconnect the terminal and the second resistor and performing a predetermined notification in a case where the voltage of the terminal connected to the second resistor is within a predetermined voltage range after the switch is controlled so as to connect the terminal and the second resistor.
